(19) United States
(12) Patent Application Publication
(10) Pub. No.: US 2026/0225038 A1
(43) Pub. Date: Aug. 6, 2026

(54) METHOD AND APPARATUS FOR VENTING A GAS

(71) Applicant: L'Air Liquide, Societe Anonyme pour l'Etude et l'Etude et l'Exploitation des Procedes Georges Claude, Paris (FR)

(72) Inventors: Jean-Baptiste Chaix, Charenton-le-Pont (FR); Samuel Amy, Champigny-sur-Marne (FR); Marine Andrich, Jouy-en-Josas (FR); Mathieu Leclerc, Paris (FR)

(21) Appl. No.: 19/456,105

(22) Filed: Jan. 22, 2026

(30) Foreign Application Priority Data
Feb. 5, 2025 (FR) FR2501194

(51) Int. Cl. B01D 53/62

(52) U.S. Cl. CPC B01D 53/62; B01D 2257/504; B01D 2258/0233; B01D 2258/025

(57) ABSTRACT

An apparatus for separating CO2 and venting a gas comprises a contacting tower (T) comprising a lower section (I) and an upper section (C), mass transfer promoting means (P) in the lower section, a CO2 capture unit (PSA, CB), means for feeding a gas to the capture unit, means for feeding a nitrogen-enriched gas (N) from the capture unit to the bottom of the lower section of the cooling tower, means for feeding water (H) above the lower section and below the upper section of the tower, and means connected at a level above the lower section for feeding thereto a gas (G) that is to be vented and is a portion of the gas that is to be separated in the capture unit.

### CROSS REFERENCE TO RELATED APPLICATIONS

This application claims the benefit of priority under 35 U.S.C. § 119(a) and (b) to French Patent Application No. FR2501194, filed Feb. 5, 2025, the entire contents of which are incorporated herein by reference.

### BACKGROUND

The present invention relates to a method and to an apparatus for venting a gas.

It is often necessary to vent a gas by dispersing it so that it is not present at ground level or in and around homes. Such a gas may contain at least 15 mol% CO2, at least 30 mol% CO2, at least 60 mol% CO2, if not at least 90% CO2.

The gas to be vented may for example originate from at least one cement works and/or from at least one lime production unit and/or from at least one combustion furnace and/or from at least one oxy-combustion unit and/or from at least one steam methane reformer (SMR) and/or from at least one autothermal reformer (ATR) and/or from a metal production unit.

Alternatively, the gas to be vented may originate from a CO2 capture unit supplied by a gas originating from at least one cement works and/or from at least one lime production unit and/or from at least one combustion furnace and/or from at least one oxy-combustion unit and/or from at least one steam methane reformer (SMR) and/or from at least one autothermal reformer (ATR).

The CO2 capture unit may comprise an adsorption separation unit and/or a unit for separation by partial condensation and/or distillation and/or solidification.

It is known practice to separate a gas coming from one of the sources mentioned above in an adsorption separation unit, for example PSA unit, producing a CO2-depleted gas and a CO2-enriched gas, the CO2-enriched gas then being fed for separation in a unit for separation by partial condensation and/or distillation and/or solidification.

Processes for capturing CO2 carried out on flue gases from: a cement works, a lime production unit, a combustion furnace, an oxy-combustion unit, an SMR, etc. usually comprise a first step of cooling and scrubbing the flue gases. Scrubbing and cooling are often carried out in one or more scrubbing towers and optionally include the injection of a basic agent. The scrubbed and cooled gas is then usually fed through a filter to remove dust before being drawn in by a first compressor. Lastly, in some configurations, a fan makes it possible to expel or intake (depending on whether the fan is positioned close to the emitter or close to the CO2 capture unit) the flue gases from the emission point to the inlet of the CO2 capture unit.

A typical example of a CO2 capture unit separates the scrubbed, cooled and compressed (and possibly dried) gas as described above by partial condensation and/or distillation and/or solidification.

The CO2 capture unit enriches the treated gas with CO2 by discharging in particular a nitrogen-enriched gas contained in the flue gases to the atmosphere via a pipe, in order to bring the gases into a safe location for the operators. The gas may for example come from the adsorption separation unit, this gas being the CO2-depleted gas, and/or from the unit for separation by partial condensation and/or distillation and/or solidification. When the flue gases contain a large amount of nitrogen (>15 mol%, preferably>25 mol%, preferably>50 mol%), the nitrogen-enriched gas can be used to produce cold water (at a temperature <25°C, preferably <15°C) by means of a water/nitrogen tower, in order to utilize this water in the CO2 capture process (such as for cooling the gas at the inlet of the dryers) or elsewhere. The nitrogen-enriched gas is colder than the water that is to be cooled because it has undergone successive transformations, such as compression, cooling and expansion, in the CO2 capture unit.

Such a process is described in EP1712858A1 and EP0503910A1.

The water/nitrogen tower can have the discharge pipe for the N2-enriched gas positioned on top of it in order to reduce:
The footprint
The civil engineering needed to support the discharge pipe for the nitrogen-enriched gas
Pressure drops
Costs (the discharge pipe starts above the water/nitrogen tower).

If the CO2 capture unit shuts down unexpectedly (for example if the scrubbing tower, the filter or the flue-gas compressor stops working), the flue gases must be able to be rapidly vented to minimize the impact on upstream equipment and in particular to avoid an unexpected shut-down of the flue-gas emitting unit due to a sudden change in the pressure downstream of the emitting unit. In addition, it is also necessary to be able to vent the flue gases while the various pieces of equipment are being started up in sequence and also if a valve opens (pressure safeguards).

Solutions for redirecting the flue gases to an emission point (such as dampers) have a reaction time (control-system reaction time and equipment reaction time) which is generally too long with respect to the disruptions that the emitting unit can accept, given the low buffer-gas capacity provided by the connection between the emitting unit and the capture unit (due in particular to the low pressures of the flue gases).

If there is already a chimney (in particular generally at the outlet of the emitting unit), the chimney may be used in the event of an unexpected shut-down of the CO2 capture unit provided that it is not too far away from the CO2 capture unit. If the emitting unit is far away from the CO2 capture unit, it then becomes necessary as regards technical feasibility and cost:
To construct a flue-gas venting chimney at the CO2 capture unit or
To construct a low-pressure pipe for conveying the flue gases from the capture unit to the existing chimney of the emitting unit, and this poses technical difficulties as regards a risk of corrosion of the pipe due to the risk of condensation of the wet acid gases.

The use of a water/nitrogen tower for the production of ice-cold water is well known for air/gas separation units. Typically, this tower consists of a metal or concrete chamber in which packings allow good contact between the water and the gas. This tower sometimes has a chimney positioned on top, depending on the local constraints on dispersing the released gas.

The material used is typically carbon steel or concrete, since the droplets contained in the emitted gas are not corrosive.

The use of a water/nitrogen tower for the production of ice-cold water is also known for units for capturing CO₂ on flue gases by partial condensation and/or distillation and/or solidification in order to produce cold water for re-use in the process. The nitrogen-enriched gas can originate from low-temperature separation by partial condensation and/or distillation and/or solidification or from an adsorption separation step upstream of the low-temperature separation. Typically, in these processes, the nitrogen-enriched, water-laden gas is vented through a dedicated chimney or through the chimney of the emitter and the nitrogen-enriched gas is vented through the pipe in connection with the water/nitrogen tower.

The invention proposes making use of a nitrogen/water tower to vent a CO2-containing gas, except for the nitrogen which is fed to the bottom of the tower. In one variant, the invention proposes combining a local chimney at for example a CO2 capture unit for discharging combustion flue gases or gases originating from combustion flue gases with a water/nitrogen tower in order to reduce the number of emission points and reduce the total number of chimneys (reducing the cost and the visual impact, and improving the compactness and the technical feasibility).

The invention makes it possible to minimize the number of pieces of equipment by grouping together the water/nitrogen tower and the local chimney for discharging gases, for example flue gases or gases originating from the treatment of flue gases (such as flue gases that have undergone a step of scrubbing with water, of scrubbing with a basic agent, of filtration and/or of compression). The invention avoids having to construct a local chimney dedicated to releasing flue gases or gases originating from the treatment of flue gases and associating the regulatory emission control instruments therewith. The invention also avoids the construction of a pipe that returns the flue gases to an existing chimney albeit one which may be far away from the CO2 capture unit. The invention also makes it possible to limit the risks of disruptions to the flue-gas emitting unit (which could lead to warnings or a triggering of the upstream unit or to operation of the upstream unit under conditions different than the intended operating conditions) due to a disruption to the CO2 capture unit, in the event of a sudden change in the process conditions and/or an unexpected shut-down of a portion of the unit. Such a shut-down can occur if valves open or if the unit exceeds a value for temperature or pressure or flow rate or composition beyond what is acceptable from an equipment design or safety perspective.

A waste gas is a gas which, at least at specific points, contains at least one pollutant, for example CO or CO2, which is fed to the atmosphere at least at specific points.

FR2976059A1 describes a method according to the preamble of Claim 1.

Provided according to one subject of the invention is a method for venting a gas, wherein:
i) during a first mode of operation, a gas flow containing at least 50 mol% nitrogen, preferably at least 70 mol% nitrogen, is fed to a contacting tower comprising a lower section and an upper section and heat and mass transfer promoting means in the lower section at a first level at the bottom of the lower section, the tower being supplied by a water flow arriving at a second level of the lower section above the first level, the gas flow being colder or at the same temperature as the water flow entering the tower, cooled water is withdrawn from the bottom of the tower and the water-enriched gas flow exits at the top of the tower to the atmosphere, no gas being fed to the tower at a level above the first level, and
ii) during a second mode of operation,
   a) a gas flow containing at least 50 mol% nitrogen is fed to the contacting tower at the first level, the tower being supplied by a water flow arriving at the second level above the first level, the gas flow being colder or at the same temperature as the water flow entering the tower, cooled water is withdrawn from the bottom of the tower, a gas that is to be vented is fed into the tower at a third level above the second level, and the gas flow enriched with water mixed with the gas, which is to be vented up and out of the tower, exits at the top of the tower, and/or
   b) after step a) or instead of step a), no gas flow containing at least 50 mol% nitrogen is fed to the contacting tower, the tower is not supplied by a water flow arriving at the second level above the first level and a gas that is to be vented is fed into the tower at a third level above the second level, and the gas flow enriched with water mixed with the gas, which is to be vented up and out of the tower, exits at the top of the tower.

According to some optional aspects:
the gas that is to be vented contains at least 15 mol% CO2.
the gas that is to be vented is at least a portion of a waste gas from a source which may be at least one combustion unit and/or at least one oxy-combustion unit and/or at least one cement works and/or at least one lime production unit and/or at least one metal production unit and/or at least one steam reforming unit and/or at least one autothermal reforming unit.
the waste gas is fed, at least during the first mode of operation, to at least one carbon-dioxide capture unit for separation.
the waste gas contains nitrogen and the gas flow fed to the tower originates from at least one or the at least one carbon dioxide capture unit, preferably from at least one CO2 adsorption or permeation unit producing a CO2-enriched gas which is then separated in the capture unit and a CO2-depleted gas which makes up the gas flow fed to the tower.
waste gas containing CO2 and nitrogen originating from a source that can be at least one combustion unit and/or at least one oxy-combustion unit and/or at least one cement works and/or at least one lime production unit and/or at least one metal production unit and/or at least one steam reforming unit and/or at least one autothermal reforming unit is fed, at least during the first and second modes of operation, to a carbon-dioxide capture unit, or wherein waste gas containing CO2 and nitrogen originating from a source that can be at least one combustion unit and/or at least one oxy-combustion unit and/or at least one cement works and/or at least one lime production unit and/or at least one metal production unit and/or at least one steam reforming unit and/or at least one autothermal reforming unit is fed, at least during the first and second modes of operation, to the at least one carbon dioxide capture unit and the gas that is to be vented originates from the at least one capture unit.
the gas that is to be vented is produced by the scrubbing of the CO2—and nitrogen-containing waste gas and/or by the compression of the CO2—and nitrogen-containing gas and/or from the adsorption or permeation separation of the CO2—and nitrogen-containing waste gas and/or from the drying of the CO2—and nitrogen-containing gas and/or from the separation by partial condensation and/or distillation and/or solidification of the CO2—and nitrogen-containing waste gas or of a gas produced by the separation of the CO2—and nitrogen-containing waste gas.
the second mode of operation corresponds to a disruption to and/or an unintended shut-down of and/or a start-up of a unit from which the gas that is to be vented originates.
in a third mode of operation directly following the second mode of operation, the gas that is to be vented is no longer fed to the tower but is fed to a discharge chimney, to which at least one other gas originating from the source is fed.
the first mode of operation corresponds to a normal mode of operation of the capture unit.
the second mode of operation lasts less than an hour, if not less than ten minutes.
in the second mode of operation, the gas that is to be vented is fed to the tower for a specific period of time and, preferably at the end of the specific period of time, the gas that is to be vented is fed elsewhere.
in the second mode of operation, a first gas that is to be vented is fed to the tower and, in a third mode of operation, a second gas to be vented is fed to the tower, the first gas and the second gas having compositions of at least one component common thereto which differ by at least 5 mol % and/or temperatures which differ by at least 40° C., the first and the second gas each being either a portion of the waste gas or a gas originating from the CO2 capture unit and the first and the second not both being fed to the tower during the second and third modes of operation.
the gas flow is at a temperature less than 20° C.
the gas flow is dry.
the gas that is to be vented is at a temperature higher than 20° C., if not higher than 70° C.
the gas to be vented is wet.
a water-droplet removing element is located below the upper portion.
the waste gas is separated by partial condensation and/or distillation and/or solidification without having been separated by adsorption to remove a component other than water.
the waste gas is separated by partial condensation and/or distillation and/or solidification after having been treated by adsorption to remove the water it contains.
the waste gas is separated by partial condensation and/or distillation and/or solidification after having been separated by adsorption to remove a component other than water, such as nitrogen and/or hydrogen.

Another object of the invention provides an apparatus for separating CO2 and venting a gas, comprising a contacting tower comprising a lower section and an upper section, heat and mass transfer promoting means in the lower section, a CO2 capture unit, means for feeding a gas possibly containing at least 15% CO2 to the CO2 capture unit, means for feeding a nitrogen-enriched gas from the CO2 capture unit to the bottom of the lower section of the cooling tower, means for feeding water above the lower section and below the upper section of the tower at a temperature hotter than or equal to that of the nitrogen-enriched gas entering the tower, and means connected at a level above the lower section for feeding thereto a gas that is to be vented and is a portion of the gas that is to be separated in the CO2 capture unit and/or a gas treated in the CO2 capture unit.

The lower section preferably has a larger diameter than the upper section.

The invention can consist in the equipment of the water/nitrogen tower combining the following functions:
Bringing the water into contact with a gas containing at least 50 mol % nitrogen and possibly other components lighter than CO2, the gas being colder than the water, in order to produce cooled water, for example at a lower temperature than the cooling-water network,
Venting, for example in a safe location, of the nitrogen-rich gas containing at least 50 mol % nitrogen and possibly other components lighter than CO2, the gas being saturated with water (gas resulting from the liquid-vapour contacting in the preceding step),
Function added by the present invention: venting to the atmosphere, for example in a safe location, of a gas originating from the flue gases of an emitting unit: i.e. connection of the exhaust line
   i) for flue gases from the emitting unit with the venting of the flue gases to the atmosphere, in the safe location, or
   ii) for flue gases from the emitting unit which have undergone a pre-treatment (for example scrubbing with water, scrubbing with a basic agent, physical filtration, compression and/or drying).

The water/nitrogen tower may be part of a CO2 capture unit and can make it possible to generate ice-cold water from a CO 2-depleted gas containing at least 50 mol% nitrogen produced by a CO2 PSA which is part of the capture unit or constitutes the capture unit. This impure nitrogen contains a significant fraction of CO2 (for example between 0.1% and 2%). Dissolving this CO2 in ice-cold water requires a water/nitrogen tower made of a material resistant to pH lower than 3.5 (or more broadly to acid pH, i.e. pH<7). The ice-cold water network is also made of materials resistant to pH lower than 3.5.

Outside of the start-up and unexpected shut-down phases, the water/nitrogen tower operates normally and conventionally: the nitrogen-enriched gas (with a nitrogen content>50 mol %, preferably>70 mol%) is injected into the bottom of the tower via a dedicated inlet. The packings in the tower allow the water that runs off above them to evaporate in order to charge the gas with water vapour. This evaporation is endothermic and makes it possible to cool the rest of the water which flows down to the bottom of the tower before it is pumped to ice-cold-water users.

The upper portion of the tower is used for at least one of the following cases: start-up or unexpected shut-down of one of the elements of the flue-gas treatment or CO2 capture unit that are shown in the below diagram (scrubbing with water, scrubbing with a basic agent, heater, blower, filtration, compression, drying, separation with a PSA-type process).

In the event of an unexpected shut-down of one of these elements, the gas at the outlet of the last element that has not been stopped is fed to the water/nitrogen tower to be vented to the atmosphere through the upper portion of the water/nitrogen tower (chimney).

In particular, if the scrubbing tower unexpectedly shuts down, hot and dirty gas must be vented to the atmosphere. This gas is generally laden with acids (NOx & SOx for example) and dust. Venting this dirty gas through the tower to the atmosphere for an excessively long period of time could run the risk of concentrating these acids and this dust in the circuit of ice-cold water. The flue gases can therefore be vented through this chimney only for a short period of time. A deconcentration purge makes it possible to deconcentrate the dust and the acids that have accumulated in the circuit of ice-cold water. Discharge into this chimney is typically limited to the period of time required to stop flue gases being introduced into the CO2 capture unit and to redirect these flue gases to the existing chimney of the emitting unit. The flue gases are redirected towards the chimney of the emitting unit by a set of valves or dampers between the emitting unit and the CO2 capture unit. The transient phase of discharging the gases in the water/nitrogen tower lasts around a few seconds to a few minutes, depending on the damper opening/closing reaction time, the reaction time of the control system (for example DCS), the volume of equipment, the sensitivity of the upstream process (of the emitting unit) to a disruption of the downstream process.

More generally, the intention is that flue gases or gases originating from the treatment of flue gases in the water/nitrogen tower are discharged transiently for reasons of choice of materials, environmental constraints and management of solid particles and impurities in the water/nitrogen tower.

The flue gases are hot and wet: venting through a cold chimney (cooled during normal operation by the nitrogen exiting the water/nitrogen tower) will cause acids and water to condense onto the walls. These acid droplets will run down into the bottom portion of the water/nitrogen tower. This does not pose a particular problem because the flue gases are vented for a limited period of time and with a limited frequency and the circuit of ice-cold water is sized to resist corrosion at a pH close to 3. In addition, it is expected that the pressure-increasing elements (blower, compressor) are triggered more frequently than the scrubbing towers are, thereby making it possible to limit the frequency with which flue gases rich in dust and strong acids (SO₃, H₂SO₄, HCl, HF, HBr, etc.) are fed to the chimney of the water/nitrogen tower.

Nitrogen and hot and dirty flue gases are never discharged simultaneously: hot and dirty flue gases are discharged only in the event of an unexpected shut-down of the scrubbing tower. However, this unexpected shut-down also involves stopping the emission of nitrogen. The exhaust gases originating from the flue gases are usually cooled and scrubbed (with water and one or more basic agents) before being fed into the chimney of the water/nitrogen tower because it is expected that the compressor will unexpectedly shut down more frequently than the scrubbing towers do. In particular, the scrubbing towers are sized such that they do not unexpectedly shut down frequently (for example redundancy of the circulation pumps).

Lastly, the invention makes it possible to concentrate all of the discharges at a single point, these discharges being continuous and/or subject to emission permits. Thus, all of the vents, in particular all those containing dangerous impurities (e.g. NOx and SOx) either during the start-up or during continuous operation of the CO2 capture unit, are directed towards this single chimney. This therefore makes it possible to have a single emission point for the entire capture unit.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 depicts a cooling tower for use in the method of the invention.

FIG. 2 diagrammatically depicts a method according to the invention.

### DETAILED DESCRIPTION OF PREFERRED EMBODIMENTS

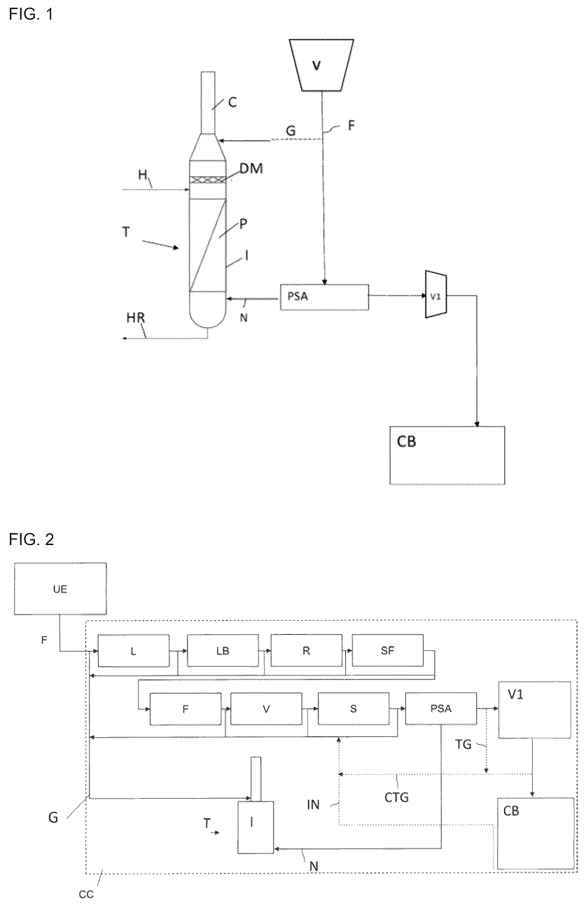

FIG. 1 shows a cooling tower comprising a lower portion I containing packings P for promoting the exchanges of mass and heat and an upper portion C, which has a smaller diameter than the lower portion and does not contain any packings. The bottom of the tower T has an inlet for gas N; the gas N, which is preferably dry, is at a temperature of less than 20° C., contains at least 50 mol % nitrogen and does not contain solid particles, and, at the top of the lower portion and below the upper portion C, the tower has a water inlet H. The tower has a cooled-water outlet HR at the bottom. In the lower portion of the tower, above the water inlet H, there is a water-droplet removing element DM, this element being located below the upper portion C. A gas inlet G for gas that is to be vented is located below the upper portion C in a frustoconical section connecting the upper portion C to the lower portion I. The gas G can be wet and be at a temperature greater than 20° C., if not greater than 70° C.

Thus, the contact between the gas N and the water H makes it possible to cool the water which exits at the bottom of the tower T. The wet nitrogen rises in the lower portion I, is freed of a portion of the water in the element DM and exits from the upper portion C mixed with the gas G, when the latter is present. When the gas G is not present, the nitrogen-rich wet gas also exits from the upper portion C.

The upper portion C, preferably only the upper portion, may be made of stainless steel of the ferritic-austenitic or austenitic steel type.

The lower and upper portions I, C can be made of stainless steel or of any other material resistant to corrosion at a pH close to 3.

The gas G is fed to the tower preferably over a short period of time depending on its composition, preferably over less than one hour, if not less than ten minutes, and the feed is regulated by a timer, a suitable regulation system and/or a set of valves or dampers.

FIG. 2 diagrammatically depicts a method according to the invention.

An emitting unit UE may be at least one cement works and/or at least one lime production unit and/or at least one combustion furnace and/or at least one oxy-combustion unit and/or at least one steam methane reformer (SMR) and/or at least one autothermal reformer (ATR).

In a first mode of operation, the emitting unit UE produces a gas F, often referred to as flue gases, which contains CO2 and nitrogen. The gas F may also contain at least one component chosen from the following list: oxygen, argon, carbon monoxide, hydrogen, dust, strong acids (SO3, H2SO4, HCl, HF, HBr, etc.), SOx, NOx. The gas 5 is fed to a CO2 capture unit CC where it is treated firstly by scrubbing with water L, and possibly then by scrubbing with basic agent LB. The scrubbed gas is heated by a heater R, compressed by a blower SF, filtered in a filtering unit to remove dust if the latter is present, compressed by a compressor V, dried by a dryer S, separated by adsorption in a unit PSA to form a CO2-enriched and nitrogen-depleted gas TG and a nitrogen-enriched and CO2-depleted gas N containing at least 50 mol % nitrogen. The CO2-enriched gas is compressed to form a compressed gas CTG, cooled and then separated by partial condensation and/or distillation and/or solidification in a low-temperature separation unit CB to form a CO2-depleted and oxygen-and/or nitrogen-and/or argon-enriched gas IN and a CO2-rich fluid CO2. The gas N is fed to the bottom of the cooling tower T in FIG. 1, the tower having a lower portion I and an upper portion C. The lower portion of the tower T is supplied by water that is to be cooled to a temperature greater than or equal to that of the gas N and the cooled water exits at the bottom of the tower T. The vaporization of the water generates cold in addition to the exchange of heat.

It may be necessary, in a second mode of operation, to feed to the air:
at least a portion of the gas F exiting from the unit UE and/or
at least a portion of the gas F treated in the capture unit CC, by a treatment using at least one of the following means: by scrubbing with water L, by scrubbing with a basic agent LB, by heating R, by compression by means of the blower SF, by filtration in a filtering unit F to remove dust if the latter is present, by compression by means of the compressor V, by drying by means of the dryer S, by separation by adsorption in a unit PSA
and/or a portion of the gas TG
and/or a portion of the gas CTG and/or
at least a portion of the gas IN.

This second mode of operation can be used if the unit CB and/or the unit PSA and/or the unit UE shuts down, with at least one gas being transiently fed to the air when the unit shuts down completely. In some cases the nitrogen N is fed to the tower T temporarily when the unit shuts down and its pressure drops. In some cases, the nitrogen N is no longer fed to the tower T whereas the gas G and/or TG and/or CTG and/or IN is fed to the tower T.

However, in the second mode of operation, it is possible for the compressor V1 downstream of the PSA to shut down but not the rest of the apparatus upstream of the compressor V1. In this case, nitrogen N and the gas G and/or TG and/or CTG and/or IN containing CO2 are fed concomitantly into the tower T (for a longer period of time than in the case above).

In this case, a gas G from the emitting unit UE that is part of the gas F or is made up of the gas F can be fed to the bottom of the upper portion C of the tower T without having been treated in the units L, LB, R, SF etc. In this case, it will probably have a temperature greater than 20° C., if not 70° C., and/or a nitrogen concentration lower than that of the gas N.

In addition or alternatively, gas G treated by at least one of the following means: by scrubbing with water L, by scrubbing with basic agent LB, by heating R, by compression by means of the blower SF, by filtration in a filtering unit F to remove dust if the latter is present, by compression by means of the compressor V, by drying by means of the dryer S, by adsorption separation in a unit PSA producing a gas TG (tail gas), by compression V1 downstream of the unit PSA producing a gas CTG (compressed tail gas) or by separation by partial condensation and/or distillation and/or scrubbing and/or solidification in the unit CB forming a CO2-depleted gas IN can be fed to the bottom of the upper portion C of the tower T. Thus G can be taken, as illustrated, downstream of the scrubbing with water L and upstream of the scrubbing with basic agent LB and/or downstream of the scrubbing with basic agent LB and upstream of a heater R and/or downstream of a heater R and upstream of a blower SF and/or downstream of a filtering unit F and upstream of a compressor V and/or downstream of a compressor V and upstream of a dryer D and/or downstream of the dryer and upstream of a separation by permeation or adsorption. It will be understood that at least one of the listed elements may be absent. Thus, if use is not made of the scrubbing with basic agent, the gas is taken between the scrubbing with water L and the heater R.

It should be understood that the gas G may consist of a mixture of at least two gases taken directly downstream of different treatment units. For example, one gas can be taken just downstream of the filtering unit G and another gas can be taken just downstream of the dryer, and the two gases can be mixed and fed to the tower above the lower portion.

The gas may also consist of gases originating from different CO2 capture units, such that the tower T serves as a venting tower common to multiple capture units.

It is possible to provide different modes of operation in order to feed various gases G to the tower at different times. For example, in the second mode of operation, a first gas that is to be vented is fed to the tower. This gas may for example be a portion of the gas F. In a third mode of operation, a second gas that is to be vented is fed to the tower, the first gas and the second gas having compositions of at least one component common thereto which differ by at least 5 mol % and/or temperatures which differ by at least 40° C. The first and the second gas are each either a portion of the waste gas F or a gas originating from the CO2 capture unit.

For example during a first step, a portion of the gas F can be fed to the tower, for example as the only constituent of the gas G, and during a second step, the gas F is no longer fed to the tower but a gas taken directly downstream of a treatment unit that is part of the capture unit can be fed to the tower. This gas can for example be a dust-free gas at a temperature lower than 70° C. that originates from one of the following sources: safety valves of the capture unit, vents of a machine of the capture unit, purge fluid in the capture unit, or a product of the capture unit that does not have the desired proportions.

The separation unit CB may comprise a temperature swing adsorption separation unit for drying the gas CTG upstream of the separation by partial condensation and/or distillation and/or scrubbing and/or solidification. During normal operation, in the first mode of operation, it is also possible to feed the purge (low flow rate) of the regeneration gas from this temperature swing adsorption separation unit TSA to the tower T, possibly by mixing it beforehand with the nitrogen N.

During start-up, in the second mode of operation, it is possible to feed nitrogen N to the tower T and gases to the tower T concomitantly (a portion of the N2 flow to the lower portion I of the tower T and a portion of a CO2-containing gas to the upper portion C of the tower T).

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for venting a gas, wherein:
i. during a first mode of operation, a gas flow (N) containing at least 50 mol % nitrogen, preferably at least 70 mol % nitrogen, is fed to a contacting tower (T) comprising a lower section (I) and an upper section (C) and heat and mass transfer promoting packings (P) in the lower section at a first level at the bottom of the lower section, the tower being supplied by a water flow (H) arriving at a second level of the lower section above the first level, the gas flow being colder or at the same temperature as the water flow entering the tower, cooled water (HR) is withdrawn from the bottom of the tower and the water-enriched gas flow exits at the top of the tower to the atmosphere, no gas being fed to the tower at a level above the first level, and characterized in that
ii. during a second mode of operation,
a) a gas flow (N) containing at least 50 mol % nitrogen is fed to the contacting tower at the first level, the tower being supplied by a water flow (H) arriving at the second level above the first level, the gas flow being colder or at the same temperature as the water flow entering the tower, cooled water (HR) is withdrawn from the bottom of the tower, a gas (G, F, TG, CTG, IN) that is to be vented is fed into the tower at a third level above the second level, and the gas flow enriched with water mixed with the gas, which is to be vented up and out of the tower, exits at the top of the tower, and/or
b) after step a) or instead of step a), no gas flow containing at least 50 mol % nitrogen is fed to the contacting tower, the contacting tower is not supplied by a water flow arriving at the second level above the first level and a gas (G, F, TG, CTG, IN) that is to be vented is fed into the tower at a third level above the second level, and the gas flow enriched with water mixed with the gas, which is to be vented up and out of the tower, exits at the top of the contacting tower.

2. The method according to claim 1, wherein the gas (G, F, TG, CTG, IN) that is to be vented contains at least 15 mol % CO2.

3. The method according to claim 1, wherein the gas that is to be vented (G) is at least a portion of a waste gas (F) from a source (UE) which may be at least one combustion unit and/or at least one oxy-combustion unit and/or at least one cement works and/or at least one lime production unit and/or at least one metal production unit and/or at least one steam reforming unit and/or at least one autothermal reforming unit.

4. The method according to claim 3, wherein the waste gas (F) is fed, at least during the first mode of operation, to at least one carbon dioxide capture unit (PSA, CC) for separation.

5. The method according to claim 1, wherein the waste gas (F) contains nitrogen and the gas flow (N) fed to the contacting tower (T) originates from at least one or the at least one carbon dioxide capture unit (PSA, CB, CC), preferably from at least one CO2 adsorption or permeation unit producing a CO2-enriched gas which is then separated in the capture unit and a CO2-depleted gas which constitutes the gas flow fed to the tower.

6. The method according to claim 3, wherein waste gas (F) containing CO2 and nitrogen originating from a source (UE) that can be at least one combustion unit and/or at least one oxy-combustion unit and/or at least one cement works and/or at least one lime production unit and/or at least one metal production unit and/or at least one steam reforming unit and/or at least one autothermal reforming unit is fed, at least during the first and second modes of operation, to a carbon dioxide capture unit (PSA, CB), and the gas (TG, CTG, IN) that is to be vented originates from the at least one capture unit (PSA, CB).

7. The method according to claim 6, wherein the gas (G, TG, CTG, IN) that is to be vented is produced by a scrubbing (L, LB) of the CO2—and nitrogen-containing waste gas and/or by a compression (V) of the CO2—and nitrogen-containing waste gas and/or from an adsorption or a permeation separation of the CO2—and nitrogen-containing waste gas and/or from a drying(S) of the CO2—and nitrogen-containing waste gas and/or from a separation by partial condensation and/or distillation and/or solidification (CB) of the CO2—and nitrogen-containing waste gas or of a gas produced by the separation of the CO2—and nitrogen-containing waste gas.

8. The method according to claim 1, wherein the second mode of operation corresponds to a disruption and/or an unintended shut-down and/or a start-up of a unit (UE, PSA, L, LB, R, SF, V, S, PSA, CB, V1) from which the gas (G, F, TG, CTG, IN) that is to be vented originates.

9. The method according to claim 3, wherein, in a third mode of operation directly following the second mode of operation, the gas (G, F, TG, CTG, IN) that is to be vented is no longer fed to the tower (T) but is fed to a discharge chimney, to which at least one other gas originating from the source (UE) is fed.

10. The method according to claim 1, wherein the first mode of operation corresponds to a normal mode of operation of the capture unit (PSA, CB, CC).

11. The method according to claim 1, wherein the second mode of operation lasts less than one hour.

12. The method according to claim 1, wherein, in the second mode of operation, the gas (G, TG, CTG, IN) that is to be vented is fed to the contacting tower (T) for a specific period of time and, at the end of the specific period of time, the gas that is to be vented is fed elsewhere.

13. The method according to claim 12, wherein, in the second mode of operation, a first gas (G, TG, CTG, IN) that is to be vented is fed to the contacting tower and, in a third mode of operation, a second gas (G, TG, CTG, IN) that is to be vented is fed to the contacting tower, the first gas and the second gas having compositions of at least one component common thereto which differ by at least 5 mol % and/or temperatures which differ by at least 40°C, the first and the second gas each being either a portion of the waste gas (F) or a gas originating from the CO2 capture unit and the first and the second not both being fed to the contacting tower during the second and third modes of operation.

14. An apparatus for separating CO2 and venting a gas, comprising a contacting tower (T) comprising a lower section (I) and an upper section (C), heat and mass transfer promoting packings (P) in the lower section, a CO2 capture unit (PSA, CB, CC), a device for feeding a gas, possibly containing at least 15% CO2, to the CO2 capture unit, a device for feeding a nitrogen-enriched gas (N) from the CO2 capture unit to the bottom of the lower section of the cooling tower, a device for feeding water (H) above the lower section and below the upper section of the tower at a temperature hotter than or equal to that of the nitrogen-enriched gas entering the tower, and a device connected at a level above the lower section for feeding thereto a gas (G, TG, CTG, IN) that is to be vented and is a portion of the gas that is to be separated in the CO2 capture unit (PSA, CB, CC) and/or a gas treated in the CO2 capture unit (PSA, CB, CC).

15. The apparatus according to claim 14, wherein the lower section (I) has a larger diameter than the upper section (C).
